(19) United States
(12) Patent Application Publication
(10) Pub. No.: US 2021/0297867 A1
(43) Pub. Date: Sep. 23, 2021

(54) MEASUREMENT CONFIGURATION TECHNIQUES FOR WIDEBAND COVERAGE ENHANCEMENT (WCE)-CAPABLE DEVICES

(71) Applicant: INTEL IP CORPORATION, Santa Clara, CA (US)

(72) Inventors: Huaning NIU, San Jose, CA (US); Seau LIM, Wiltshire (GB); Anthony LEE, San Diego, CA (US); Candy YIU, Portland, OR (US); Youn Hyoung HEO, Seoul (KR)

(73) Assignee: INTEL IP CORPORATION, SANTA CLARA, CA (US)

(21) Appl. No.: 16/604,836

(22) PCT Filed: May 10, 2018
(86) PCT No.: PCT/US2018/032171

§ 371 Date: Oct. 11, 2019

Related U.S. Application Data
(60) Provisional application No. 62/504,228, filed on May 10, 2017.

(51) Int. Cl. H04W 16/14; H04W 24/10; H04W 8/00; H04L 5/00

(52) U.S. Cl. CPC H04W 16/14; H04L 5/0051; H04W 8/005; H04W 24/10

(57) ABSTRACT

Measurement configuration techniques for wideband coverage enhancement (WCE)-capable devices are described. According to various such techniques, a WCE-capable UE may be configured to recognize and apply distinct respective discovery signal measurement timing configurations (DMTCs) for WCE discovery reference signal (DRS) measurements and non-WCE DRS measurements. In some embodiments, the DMTC for WCE DRS measurements may specify a longer measurement periodicity for WCE DRS measurements than that applicable to non-WCE DRS measurements. In some embodiments, the DMTC for WCE DRS measurements may specify a larger measurement window for WCE DRS measurements than that applicable to non-WCE DRS measurements. In some embodiments, the WCE-capable UE may be configured to recognize and distinct respective measurement gap configurations for WCE and non-WCE measurements. Other embodiments are described and claimed.

### RELATED CASE

This application claims priority to U.S. Provisional Patent Application No. 62/504,228, filed May 10, 2017, which is hereby incorporated by reference in its entirety.

### TECHNICAL FIELD

Embodiments herein generally relate to wireless communications in mobile cellular radio access networks. Some embodiments may be related to the LTE operation in unlicensed spectrum in MulteFire, specifically the wideband coverage enhancement (WCE) for MulteFire.

### BACKGROUND

The standalone LTE system in the unlicensed spectrum, where LTE-based technology solely operates in unlicensed spectrum without requiring an “anchor” in licensed spectrum, is defined in MulteFire 1.0. To enable usage case for wideband IoT, the wideband coverage enhancement WI is approved in MF1.1.

IoT is envisioned as a significantly important technology component, which has huge potential and may change our daily life entirely by enabling connectivity between tons of devices. IoT has wide applications in various scenarios, including smart cities, smart environment, smart agriculture, and smart health systems.

3GPP has standardized two designs to support IoT services—enhanced Machine Type Communication (eMTC) and NarrowBand IoT (NB-IoT). As eMTC and NB-IoT UEs will be deployed in huge numbers, lowering the cost of these UEs is a key enabler for implementation of IoT. Also, low power consumption is desirable to extend the life time of the battery. In addition, there is a substantial use cases of devices deployed deep inside buildings, which would require coverage enhancement (CE) in comparison to the defined LTE cell coverage footprint. In summary, eMTC and NB-IoT techniques are designed to ensure that the UEs have low cost, low power consumption and enhanced coverage. To extend the benefits of LTE IoT designs into unlicensed spectrum, MulteFire 1.1 is expected to specify the design for Unlicensed-IoT (U-IoT) based on eMTC and/or NB-IoT. The unlicensed frequency band of current interest for NB-IoT or eMTC based U-IoT is the sub-1 GHz band and the ˜2.4 GHz band.

Besides, different from eMTC and NB-IoT which applies to narrowband operation, WCE is also agreed as one of the MulteFire 1.1 work item with operation bandwidth of 10 MHz and 20 MHz. The objective of WCE is to extend the MulteFire 1.0 coverage to meet industry IoT market need, with the targeting operating bands at 3.5 GHz and 5 GHz.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a fourth operating environment.

FIG. 5 illustrates an embodiment of a first logic flow.

FIG. 6 illustrates an embodiment of a second logic flow.

FIG. 7 illustrates an embodiment of a first storage medium and an embodiment of a second storage medium.

FIG. 8 illustrates an embodiment of a system architecture.

FIG. 9 illustrates an embodiment of a device.

FIG. 10 illustrates an embodiment of baseband circuitry.

FIG. 11 illustrates an embodiment of a control plane protocol stack.

FIG. 12 illustrates an embodiment of a set of hardware resources.

### DETAILED DESCRIPTION

Measurement configuration techniques for wideband coverage enhancement (WCE)-capable devices are described. According to various such techniques, a WCE-capable UE may be configured to recognize and apply distinct respective discovery signal measurement timing configurations (DMTCs) for WCE discovery reference signal (DRS) measurements and non-WCE DRS measurements. In some embodiments, the DMTC for WCE DRS measurements may specify a longer measurement periodicity for WCE DRS measurements than that applicable to non-WCE DRS measurements. In some embodiments, the DMTC for WCE DRS measurements may specify a larger measurement window for WCE DRS measurements than that applicable to non-WCE DRS measurements. In some embodiments, the WCE-capable UE may be configured to recognize and distinct respective measurement gap configurations for WCE and non-WCE measurements. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 3GPP LTE-Advanced Pro, and/or 3GPP fifth generation (5G)/new radio (NR) technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally or alternatively involve wireless communications according to other wireless communications technologies and/or standards. Examples of other wireless communications technologies and/or standards that may be used in various embodiments may include, without limitation, other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11ah, IEEE 802.11ax, IEEE 802.11ay, and/or IEEE 802.11y standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards, and/or near-field communication (NFC) standards such as standards developed by the NFC Forum, including any revisions, progeny, and/or variants of any of the above. The embodiments are not limited to these examples.

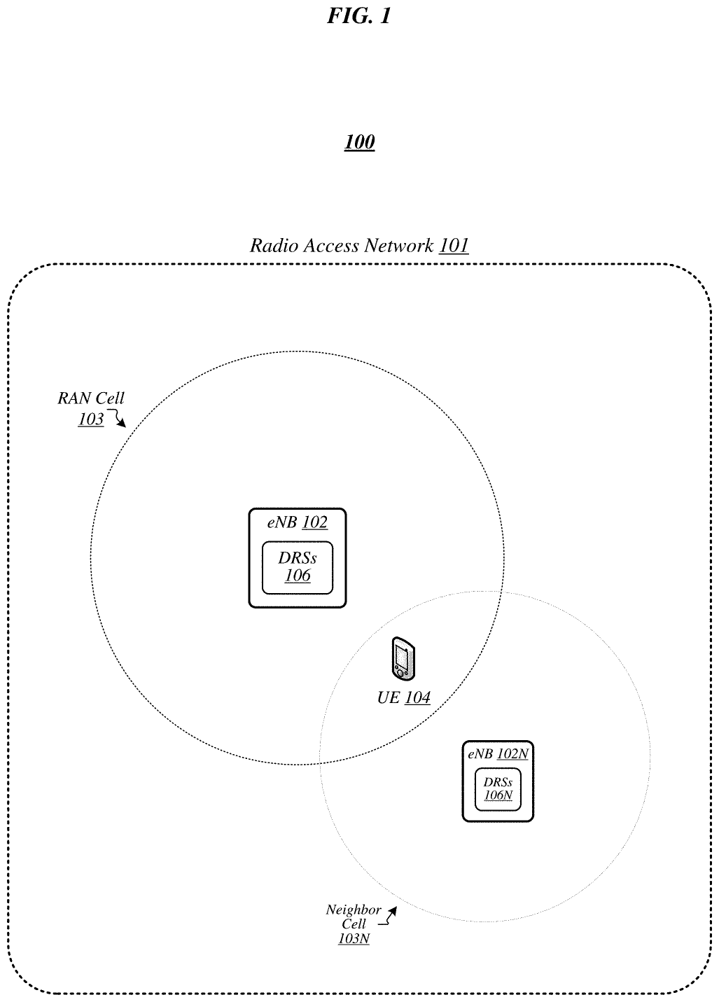

FIG. 1 illustrates an example of an operating environment 100 that may be representative of various embodiments. In operating environment 100, an evolved node B (eNB) 102 serves a radio access network (RAN) cell 103 of a radio access network 101. Radio access network 101 may generally be representative of a mobile cellular radio access network within which wireless communications are performed using unlicensed spectrum. In some embodiments, radio access network 101 may be representative of a MulteFire RAN, and RAN cell 103 may be representative of a MulteFire cell within that MulteFire RAN. In such embodiments, eNB 102 and UE 104 may wirelessly communicate with each other, using unlicensed spectrum, in accordance with MulteFire radio interface protocols.

RAN cell 103 may generally be representative of one of a plurality of RAN cells of radio access network 101, and may constitute a serving cell of user equipment (UE) 104. The other RAN cells of radio access network 101 may include one or more RAN cells that neighbor RAN cell 103 (collectively, the “neighbor cells” of RAN cell 103). In various embodiments, the neighbor cells of RAN cell 103 may include one or more RAN cells that operate on a same carrier frequency as does RAN cell 103. In some embodiments, the neighbor cells of RAN cell 103 may additionally or alternatively include one or more RAN cells that operate on different carrier frequencies than does RAN cell 103. In various embodiments, the neighbor cells operating on a given carrier frequency may include one or more synchronous neighbor cells, comprising neighbor cells for which timing synchronization with RAN cell 103 exists. In some embodiments, the neighbor cells operating on the given carrier frequency may additionally or alternatively include one or more asynchronous neighbor cells, comprising neighbor cells for which timing synchronization with RAN cell 103 does not exist.

In operating environment 100, the eNBs serving the various RAN cells in radio access network 101 may generally be operative to transmit discovery reference signals (DRSs) on a recurring basis. Transmission of such DRSs may enable UEs in radio access network 101 to discover the RAN cells that transmit those DRSs. UE 104 may perform various types of radio resource management (RRM) measurements based on such DRSs while operating within radio access network 101. Such RRM measurements may be referred to as DRS measurements. The DRS measurements that UE 104 may perform while operating in radio access network 101 may include serving cell DRS measurements, which UE 104 may perform based on DRSs transmitted in its serving cell. In the example of FIG. 1, in which RAN cell 103 constitutes the serving cell of UE 104, UE 104 may perform serving cell DRS measurements based on DRSs 106 transmitted by eNB 102. The DRS measurements that UE 104 may perform while operating within radio access network 101 may also include neighbor cell DRS measurements, which UE 104 may perform based on DRSs transmitted in RAN cells neighboring UE 104's serving cell. For example, UE 104 may perform neighbor cell DRS measurements based on DRSs 106N transmitted by an eNB 102N that serves a neighbor cell 103N, which may represent one of a plurality of neighbor cells of RAN cell 103. The embodiments are not limited to these examples.

According to a DRS transmission timing scheme governing DRS transmissions in radio access network 101, eNBs serving RAN cells of radio access network 101 may perform DRS transmissions during periodic DRS transmission windows. Each such periodic DRS transmission window may constitute a time interval over the course of which at least one DRSs transmission is to be completed, pending availability of the wireless medium. A given DRS transmission may take place over the course of a DRS occasion, which may represent a time interval within a DRS transmission window and may comprise a duration of one subframe.

In a given RAN cell of radio access network 101, a discovery signal measurement timing configuration (DMTC) applicable to DRS transmissions of that cell may generally characterize various aspects of the timings of DRS transmissions in that cell. More particularly, the applicable DMTC configuration may specify values for DMTC parameters that control DRS transmission timing. Collectively, the specified values may define periodic DMTC occasions that constitute the periodic DRS transmission windows for DRS transmissions in the cell. In various embodiments, the DMTC parameters for which the applicable DMTC configuration in a given RAN cell specifies values may include a dmtc-Periodicity parameter, a dmtc-Offset parameter, and a dmtc-WindowSize parameter.

The value of the dmtc-Periodicity parameter may specify the periodicity of the DMTC occasions that constitute the periodic DRS transmission windows in the cell, and the value of the dmtc-WindowSize parameter may specify the duration of each such DMTC occasion. The value of the dmtc-Offset parameter may define the respective starting subframe for each such DMTC occasion, and may be usable to identify the respective system frame number (SFN) and subframe number associated with each such starting subframe. In some embodiments, the set of possible values defined for the dmtc-Periodicity parameter may support periodicities of 40, 80, and 160 ms. In various embodiments, the set of possible values defined for the dmtc-WindowSize parameter may comprise the set of integers [1 . . . 10], supporting DRS transmission windows durations of 1 to 10 ms. In some embodiments, the set of possible values defined for the dmtc-Offset parameter may comprise the set of integers [0 . . . 159].

UE 104 may generally perform DRS measurements during periodic DRS measurement windows. Each such periodic DRS measurement window may constitute a time interval during which UE 104 is to “listen” for DRS transmissions. A DMTC configuration applicable to a given carrier frequency may specify DMTC parameter values that collectively define periodic DMTC occasions that constitute DRS measurement windows for DRS measurements on that carrier frequency. These DMTC parameter values may include values for the dmtc-Periodicity, dmtc-Offset, and dmtc-WindowSize parameters discussed above.

As serving eNB of UE 104, eNB 102 may generally be operative to control/manage various aspects of measurement operations of UE 104. In various embodiments, in conjunction with this role, eNB 102 may control/manage various aspects of the timings according to which UE 104 performs neighbor cell DRS measurements. In some embodiments, eNB 102 may control/manage the timings of UE 104's neighbor cell DRS measurements on a per-frequency basis, using frequency-specific measurement objects. In various embodiments, eNB 102 may control/manage the timings of UE 104's neighbor cell DRS measurements on a given carrier frequency by providing a neighbor cell DMTC configuration for a measurement object corresponding to that frequency.

In some embodiments, UE 104 may only be able to wirelessly communicate on one carrier frequency at a given time. In such embodiments, while tuned to a carrier frequency different than that used in RAN cell 103, UE 104 may be unable to transmit to eNB 102 or receive transmissions from eNB 102. In order to enable UE 104 to tune to a different carrier frequency and perform DRS measurements on that frequency without fear of missing downlink data transmissions or uplink transmission opportunities in RAN cell 103, eNB 102 may define periodic measurement gaps. eNB 102 and UE 104 may mutually understand each such measurement gap to represent a time interval during which UE 104 will not be party to any DL or UL communications in RAN cell 103. eNB 102 may schedule around such measurement gaps in conjunction with scheduling DL transmissions to UE 104 and UL transmissions of UE 104 in RAN cell 103. In conjunction with defining measurement gaps for UE 104, eNB 102 may provide UE 104 with a measurement gap configuration (MGC) that specifies various aspects of those measurement gaps, such as their periodicity and duration.

In various embodiments, in each of the various cells in the vicinity of UE 104, the periodicity of the DRS transmission windows therein may be a positive integer multiple of 40 ms, such as 40 ms, 80 ms, or 160 ms. In an asynchronous environment, the implementation of measurement gap periodicity that also comprises a positive integer multiple of 40 ms may potentially be problematic with respect to asynchronous cells operating on carrier frequencies other than that of UE 104's serving cell. If the periodicities of UE 104's measurement gaps and the DRS transmission windows of such asynchronous cells are both integer multiples of 40 ms, the relative time offset between UE 104's measurement gaps and the DRS transmission windows in such cells may remain constant over time. This creates the possibility that each successive DRS transmission window of a given such asynchronous cell may fall in between two measurement gaps of UE 104, such that DRS transmissions of that cell never occur during UE 104's DRS measurement windows for the carrier frequency in question (as those DRS measurement windows must occur during measurement gaps).

In view of this issue, measurement gaps for devices in radio access network 101 may be configured according to a scheme that supports sliding measurement gaps featuring periodicities that are not integer multiples of 40 ms. According to such a scheme, eNB 102 may provide UE 104 with an MGC that specifies values of a gap Offset parameter, a gapLength parameter, and a gapShiftFactor parameter. The value of the gapOffset parameter may both specify a measurement gap repetition period (MGRP) and define the starting subframes of the measurement gaps. The gapLength parameter may specify a measurement gap length (MGL) representing the duration of the each measurement gap as an integer number of subframes. The value of the gapShiftFactor parameter may indicate whether a gap shift is to be applied, such that the actual periodicity of the measurement gaps differs from the MGRP. In some embodiments, the MGRP may comprise 40 ms or 80 ms. In various embodiments, the MGL may comprise 6 ms, 8 ms, or 10 ms. The embodiments are not limited in this context.

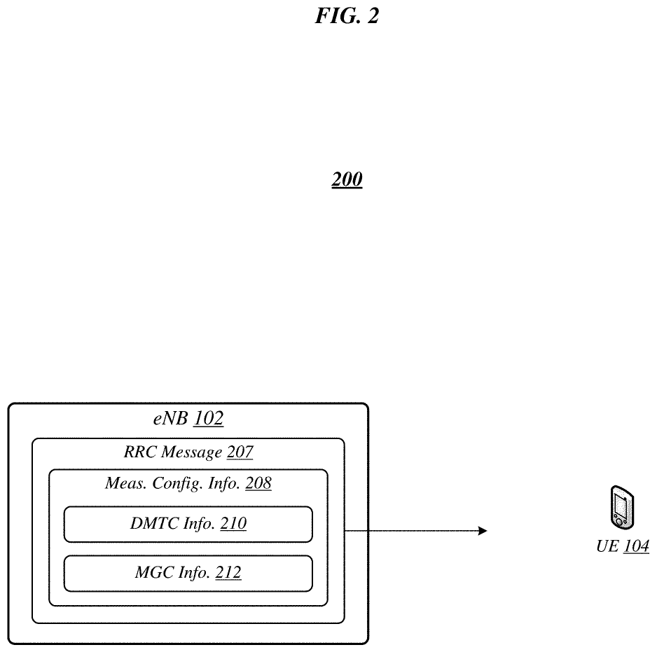

FIG. 2 illustrates an example of an operating environment 200 that may be representative of some embodiments. In operating environment 200, in order to control measurement operations on the part of UE 104, eNB 102 provides UE 104 with measurement configuration information 208. Measurement configuration information 208 may generally comprise information specifying various aspects of the measurement operations of UE 104. According to various embodiments, measurement configuration information 208 may be representative of information comprised in a MeasConfig-MF information element. In some embodiments, eNB 102 may provide UE 104 with measurement configuration information 208 via radio resource control (RRC) signaling, by including measurement configuration information 208 in an RRC message 207 that it sends to UE 104. According to various embodiments, RRC message 207 may be representative of an RRCConnectionReconfiguration-MF message. The embodiments are not limited in this context.

In some embodiments, measurement configuration information 208 may comprise DMTC information 210. DMTC information 210 may generally comprise information describing one or more DMTCs to be applied by UE 104. In various embodiments, DMTC information 210 may include information indicating values for one or more DMTC parameters of a DMTC configuration applicable to DRS measurements to be performed by UE 104 on an unlicensed carrier frequency, such as a carrier frequency of a MulteFire RAN cell. In some embodiments, DMTC information 210 may indicate respective values for one or more of a dmtc-Periodicity parameter for the DMTC configuration, a dmtc-Offset parameter for the DMTC configuration, and a dmtc-WindowSize parameter for the DMTC configuration. In various embodiments, DMTC information 210 may be comprised in a MeasDS-Config-MF information element (IE). The embodiments are not limited in this context.

In some embodiments, measurement configuration information 208 may comprise MGC information 212. MGC information 212 may generally comprise information describing an MGC to be applied by UE 104. In various embodiments, MGC information 212 may include information indicating values for one or more MGC parameters for the MGC. In some embodiments, MGC information 212 may indicate respective values for one or more of a gapOffset parameter for the MGC, a gapLength parameter for the MGC, and a gapShiftFactor parameter for the MGC. In various embodiments, MGC information 212 may be comprised in a MeasGapConfig-MF IE. The embodiments are not limited in this context.

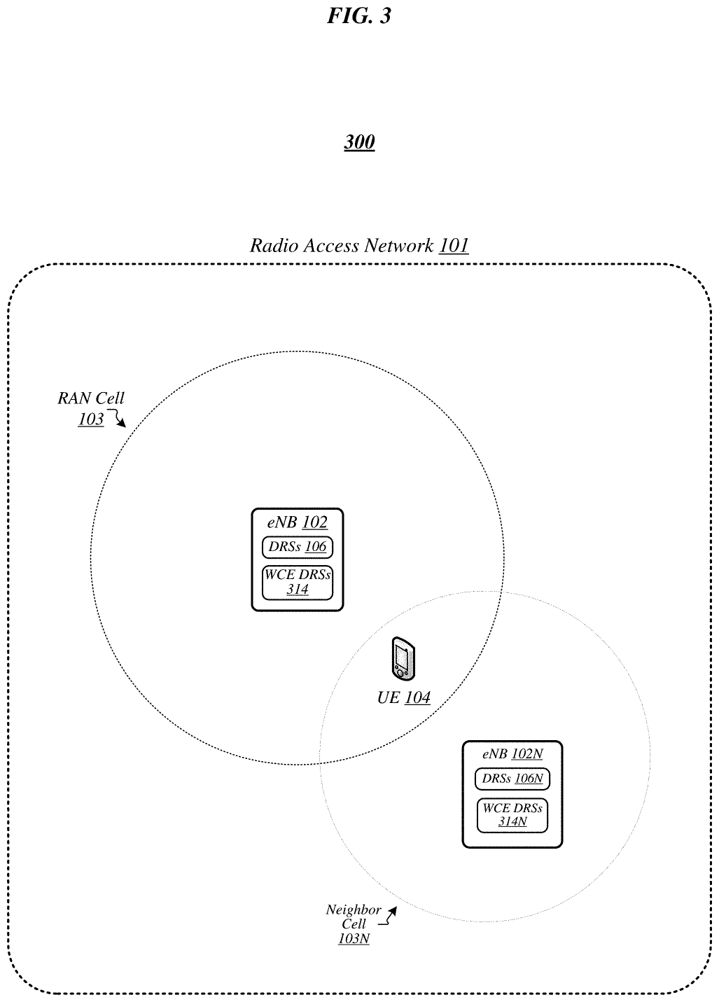

FIG. 3 illustrates an example of an operating environment 300 that may be representative of some embodiments. In operating environment 300, eNBs 102 and 102N may transmit WCE DRSs 314 and 314N on a recurring basis in order to enable WCE-capable UEs to perform combining over multiple subframes in conjunction with cell search and measurement. A given WCE DRS transmission may take place over the course of a WCE DRS occasion comprising a duration of multiple subframes over the course of which discovery reference signals are repeatedly transmitted. In various embodiments, UE 104 may be a WCE-capable UE, and may perform various types of RRM measurements based on such WCE DRSs while operating within radio access network 101. Such RRM measurements may be referred to as WCE DRS measurements, and may include serving cell WCE DRS measurements and neighbor cell WCE DRS measurements according to some embodiments. The embodiments are not limited in this context.

In various embodiments, to control overall overhead, it may be desirable that WCE DRS occasions occur less frequently than non-WCE DRS occasions, and that periodicities of WCE DRS transmission windows be longer than periodicities of non-WCE DRS transmission windows. In some embodiments, it may be desirable to implement a longer MGL to account for the longer durations of WCE DRS transmissions and longer periodicities of WCE DRS transmission windows. In some embodiments, in asynchronous environments, it may also be desirable to enable the application of a different gap shift for the purpose of WCE DRS measurements than that applied for the purpose of non-WCE DRS measurements.

In various embodiments, in order to support these types of flexibility, an enhanced measurement configuration scheme may be implemented in radio access network 101. In various embodiments, the enhanced measurement configuration scheme may enable configuration of separate DMTCs for WCE DRSs measurements and non-WCE DRS measurements of WCE-capable UEs. In some embodiments, a DMTC governing WCE DRS measurements of such a WCE-capable UE may be used to specify a longer measurement periodicity for WCE DRS measurements than that applicable to non-WCE DRS measurements. In some embodiments, a DMTC governing WCE DRS measurements of such a WCE-capable UE may be used to specify a larger measurement window for WCE DRS measurements than that applicable to non-WCE DRS measurements. The embodiments are not limited in this context.

In some embodiments, the enhanced measurement configuration scheme may enable configuration of separate WCE and non-WCE MGCs for WCE-capable UEs. In some embodiments, a WCE MGC for a WCE-capable UE may be used to specify a larger MGL than that specified by a non-WCE MGC for the WCE-capable UE. In some embodiments, a WCE MGC for a WCE-capable UE may be used to specify a different gap shift than that specified by a non-WCE MGC for the WCE-capable UE. The embodiments are not limited in this context.

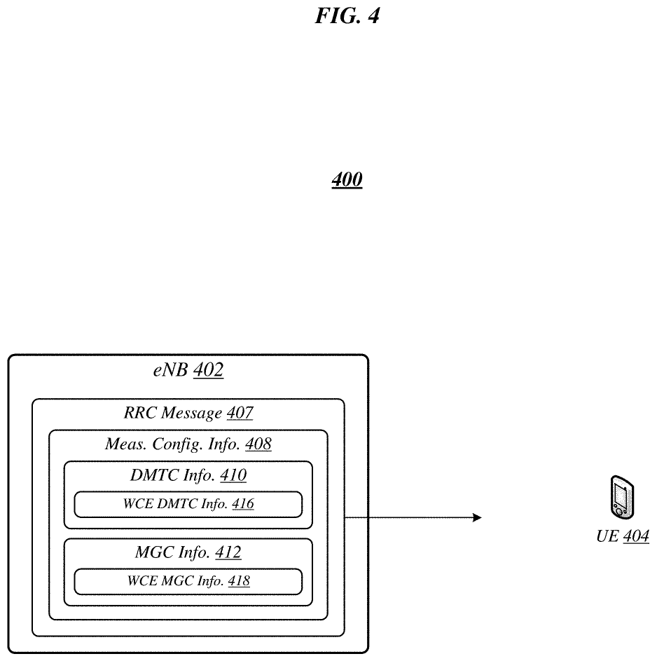

FIG. 4 illustrates an example of an operating environment 400 that may be representative of the implementation of such an enhanced measurement configuration scheme according to some embodiments. In operating environment 400, eNB 102 may constitute a serving eNB of a UE 404, which may represent a WCE-capable UE operating in RAN cell 103. In order to control measurement operations on the part of UE 404, eNB 102 may provide UE 404 with measurement configuration information 408. According to some embodiments, measurement configuration information 408 may be representative of information comprised in a MeasConfig-MF information element. In various embodiments, eNB 102 may provide UE 404 with measurement configuration information 408 via radio resource control (RRC) signaling, by including measurement configuration information 408 in an RRC message 407 that it sends to UE 404. According to some embodiments, RRC message 407 may be representative of an RRCConnectionReconfiguration-MF message. The embodiments are not limited in this context.

In various embodiments, measurement configuration information 408 may comprise DMTC information 410. DMTC information 410 may generally comprise information describing one or more DMTCs to be applied by UE 404. In some embodiments, DMTC information 410 may include WCE DMTC information 416. In some embodiments, WCE DMTC information 416 may include information indicating values for one or more DMTC parameters of a WCE DMTC configuration applicable to WCE DRS measurements to be performed by UE 404 on an unlicensed carrier frequency, such as a carrier frequency of a MulteFire RAN cell. In various embodiments, WCE DMTC information 416 may indicate respective values for one or more of a dmtc-Periodicity parameter for the WCE DMTC configuration, a dmtc-Offset parameter for the WCE DMTC configuration, and a dmtc-WindowSize parameter for the WCE DMTC configuration. In some embodiments, WCE DMTC information 416 may be comprised in a MeasDS-Config-MF IE. The embodiments are not limited in this context.

In some embodiments, in addition to WCE DMTC information 416, DMTC information 410 may include information indicating values for one or more DMTC parameters of a non-WCE DMTC configuration applicable to non-WCE DRS measurements to be performed by UE 404 on the unlicensed carrier frequency. In some embodiments, such information may indicate respective values for one or more of a dmtc-Periodicity parameter for the non-WCE DMTC configuration, a dmtc-Offset parameter for the non-WCE DMTC configuration, and a dmtc-WindowSize parameter for the non-WCE DMTC configuration. In some embodiments, such information may represent information comprised in a same MeasDS-Config-MF IE as WCE DMTC information 416. The embodiments are not limited in this context.

In various embodiments, measurement configuration information 408 may comprise MGC information 412. MGC information 412 may generally comprise information describing one or more MGCs to be applied by UE 404. In some embodiments, MGC information 412 may include WCE MGC information 418. In various embodiments, WCE MGC information 418 may include information indicating values for one or more MGC parameters for a WCE MGC to be applied by UE 404. In some embodiments, WCE MGC information 418 may indicate respective values for one or more of a gap Offset parameter for the WCE MGC, a gapLength parameter for the WCE MGC, and a gapShiftFactor parameter for the WCE MGC. In various embodiments, WCE MGC information 418 may be comprised in a MeasGapConfig-MF IE. The embodiments are not limited in this context.

In various embodiments, in addition to WCE MGC information 418, MGC information 412 may include information indicating values for one or more MGC parameters for a non-WCE MGC to be applied by UE 404. In some embodiments, such information may indicate respective values for one or more of a gap Offset parameter for the non-WCE MGC, a gapLength parameter for the non-WCE MGC, and a gapShiftFactor parameter for the non-WCE MGC. In some embodiments, such information may be comprised in a MeasGapConfig-MF IE. In various such embodiments, the MeasGapConfig-MF IE may be a different MeasGapConfig-MF IE than one that comprises WCE MGC information 418. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

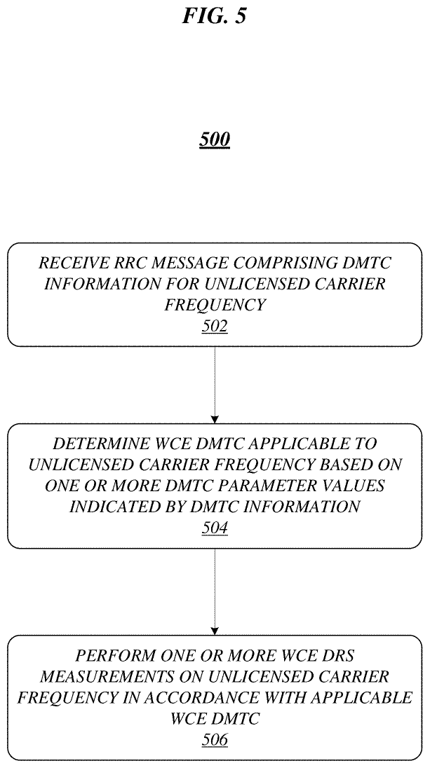

FIG. 5 illustrates one embodiment of a logic flow 500, which may be representative of operations that may be performed by UE 404 in operating environment 400 of FIG. 4 according to some embodiments. As shown in FIG. 5, an RRC message comprising DMTC information for an unlicensed carrier frequency may be received at 502. For example, UE 404 may receive RRC message 407, which may comprise DMTC information 410. At 504, a WCE DMTC applicable to the unlicensed carrier frequency may be determined based on one or more DMTC parameter values indicated by the DMTC information. For example, an applicable WCE DMTC may be determined based on one or more DMTC parameter values indicated by WCE DMTC information 416 comprised in DMTC information 410. At 506, one or more WCE DRS measurements may be performed on the unlicensed carrier frequency in accordance with the applicable WCE DMTC. For example, UE 404 may perform one or more WCE DRS measurements on an unlicensed carrier frequency in accordance with the applicable WCE DMTC determined at 504. The embodiments are not limited to these examples.

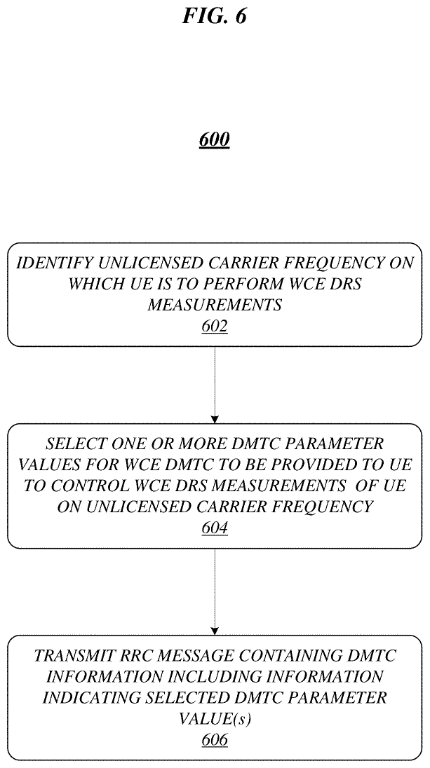

FIG. 6 illustrates one embodiment of a logic flow 600, which may be representative of operations that may be performed by eNB 402 in operating environment 400 of FIG. 4 according to some embodiments. As shown in FIG. 6, an unlicensed carrier frequency on which a UE is to perform WCE DRS measurements may be identified at 602. For example, eNB 402 may identify an unlicensed carrier frequency on which UE 404 is to perform WCE DRS measurements. At 604, one or more DMTC parameter values may be selected for a WCE DMTC to be provided to the UE to control WCE DRS measurements of the UE on the unlicensed carrier frequency. For example, eNB 402 may select one or more DMTC parameter values for a WCE DMTC to be provided to UE 404 to control WCE DRS measurements of UE 404 on an unlicensed carrier frequency identified at 602. At 606, an RRC message may be transmitted that contains DMTC information including information indicating the one or more DMTC parameter values selected at 604. For example, eNB 402 may transmit RRC message 407, which may contain DMTC information 410 including WCE DMTC information 416 that indicates the one or more DMTC parameter values selected at 604. The embodiments are not limited to these examples.

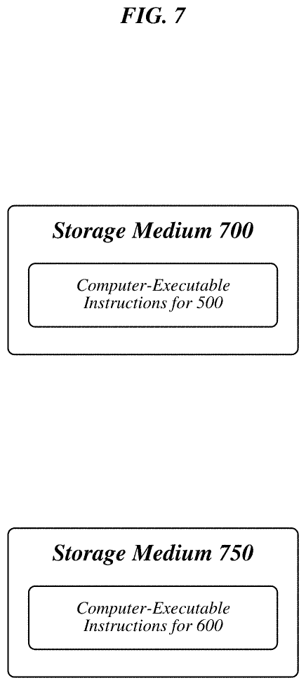

FIG. 7 illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions to implement logic flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

FIG. 7 also illustrates an embodiment of a storage medium 750. Storage medium 750 may comprise any non-transitory computer-readable storage medium or machine-readable storage medium, such as an optical, magnetic or semiconductor storage medium. In various embodiments, storage medium 750 may comprise an article of manufacture. In some embodiments, storage medium 750 may store computer-executable instructions, such as computer-executable instructions to implement logic flow 600 of FIG. 6.

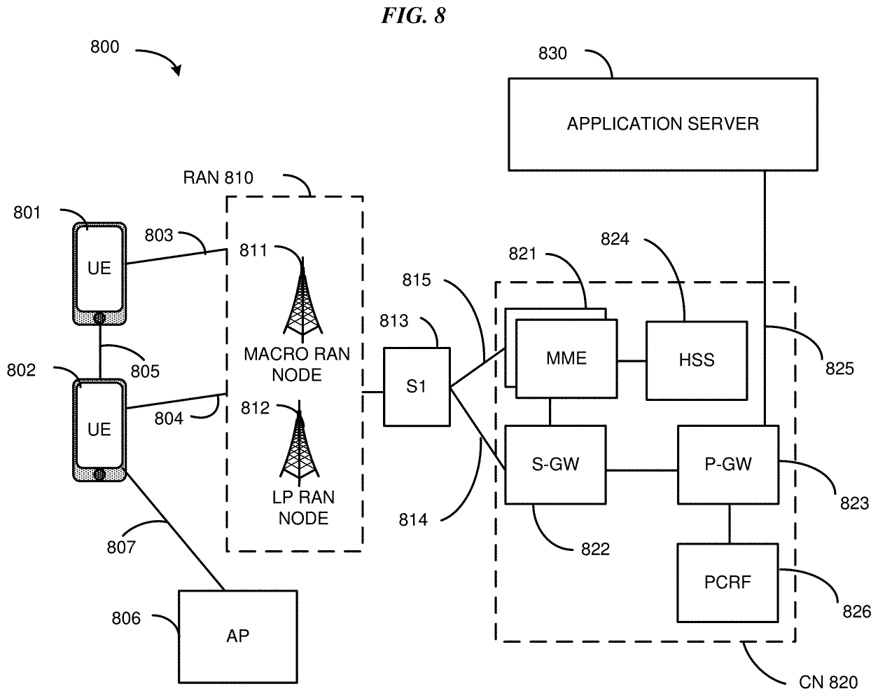

FIG. 8 illustrates an architecture of a system 800 of a network in accordance with some embodiments. The system 800 is shown to include a user equipment (UE) 801 and a UE 802. The UEs 801 and 802 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 801 and 802 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 801 and 802 may be configured to connect, e.g., communicatively couple, with a radio access network (RAN) 810—the RAN 810 may be, for example, an Evolved Universal Mobile Telecommunications System (UMTS) Terrestrial Radio Access Network (E-UTRAN), a NextGen RAN (NG RAN), or some other type of RAN. The UEs 801 and 802 utilize connections 803 and 804, respectively, each of which comprises a physical communications interface or layer (discussed in further detail below); in this example, the connections 803 and 804 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 801 and 802 may further directly exchange communication data via a ProSe interface 805. The ProSe interface 805 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 802 is shown to be configured to access an access point (AP) 806 via connection 807. The connection 807 can comprise a local wireless connection, such as a connection consistent with any IEEE 802.11 protocol, wherein the AP 806 would comprise a wireless fidelity (WiFi®) router. In this example, the AP 806 is shown to be connected to the Internet without connecting to the core network of the wireless system (described in further detail below).

The RAN 810 can include one or more access nodes that enable the connections 803 and 804. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 810 may include one or more RAN nodes for providing macrocells, e.g., macro RAN node 811, and one or more RAN nodes for providing femtocells or picocells (e.g., cells having smaller coverage areas, smaller user capacity, or higher bandwidth compared to macrocells), e.g., low power (LP) RAN node 812.

Any of the RAN nodes 811 and 812 can terminate the air interface protocol and can be the first point of contact for the UEs 801 and 802. In some embodiments, any of the RAN nodes 811 and 812 can fulfill various logical functions for the RAN 810 including, but not limited to, radio network controller (RNC) functions such as radio bearer management, uplink and downlink dynamic radio resource management and data packet scheduling, and mobility management.

In accordance with some embodiments, the UEs 801 and 802 can be configured to communicate using Orthogonal Frequency-Division Multiplexing (OFDM) communication signals with each other or with any of the RAN nodes 811 and 812 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 811 and 812 to the UEs 801 and 802, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 801 and 802. The physical downlink control channel (PDCCH) may carry information about the transport format and resource allocations related to the PDSCH channel, among other things. It may also inform the UEs 801 and 802 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 811 and 812 based on channel quality information fed back from any of the UEs 801 and 802. The downlink resource assignment information may be sent on the PDCCH used for (e.g., assigned to) each of the UEs 801 and 802.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 810 is shown to be communicatively coupled to a core network (CN) 820—via an S1 interface 813. In embodiments, the CN 820 may be an evolved packet core (EPC) network, a NextGen Packet Core (NPC) network, or some other type of CN. In this embodiment the S1 interface 813 is split into two parts: the S1-U interface 814, which carries traffic data between the RAN nodes 811 and 812 and the serving gateway (S-GW) 822, and the S1-mobility management entity (MME) interface 815, which is a signaling interface between the RAN nodes 811 and 812 and MMEs 821.

In this embodiment, the CN 820 comprises the MMEs 821, the S-GW 822, the Packet Data Network (PDN) Gateway (P-GW) 823, and a home subscriber server (HSS) 824. The MMEs 821 may be similar in function to the control plane of legacy Serving General Packet Radio Service (GPRS) Support Nodes (SGSN). The MMEs 821 may manage mobility aspects in access such as gateway selection and tracking area list management. The HSS 824 may comprise a database for network users, including subscription-related information to support the network entities' handling of communication sessions. The CN 820 may comprise one or several HSSs 824, depending on the number of mobile subscribers, on the capacity of the equipment, on the organization of the network, etc. For example, the HSS 824 can provide support for routing/roaming, authentication, authorization, naming/addressing resolution, location dependencies, etc.

The S-GW 822 may terminate the S1 interface 813 towards the RAN 810, and routes data packets between the RAN 810 and the CN 820. In addition, the S-GW 822 may be a local mobility anchor point for inter-RAN node handovers and also may provide an anchor for inter-3GPP mobility. Other responsibilities may include lawful intercept, charging, and some policy enforcement.

The P-GW 823 may terminate an SGi interface toward a PDN. The P-GW 823 may route data packets between the EPC network 823 and external networks such as a network including the application server 830 (alternatively referred to as application function (AF)) via an Internet Protocol (IP) interface 825. Generally, the application server 830 may be an element offering applications that use IP bearer resources with the core network (e.g., UMTS Packet Services (PS) domain, LTE PS data services, etc.). In this embodiment, the P-GW 823 is shown to be communicatively coupled to an application server 830 via an IP communications interface 825. The application server 830 can also be configured to support one or more communication services (e.g., Voice-over-Internet Protocol (VoIP) sessions, PTT sessions, group communication sessions, social networking services, etc.) for the UEs 801 and 802 via the CN 820.

The P-GW 823 may further be a node for policy enforcement and charging data collection. Policy and Charging Enforcement Function (PCRF) 826 is the policy and charging control element of the CN 820. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 826 may be communicatively coupled to the application server 830 via the P-GW 823. The application server 830 may signal the PCRF 826 to indicate a new service flow and select the appropriate Quality of Service (QoS) and charging parameters. The PCRF 826 may provision this rule into a Policy and Charging Enforcement Function (PCEF) (not shown) with the appropriate traffic flow template (TFT) and QoS class of identifier (QCI), which commences the QoS and charging as specified by the application server 830.

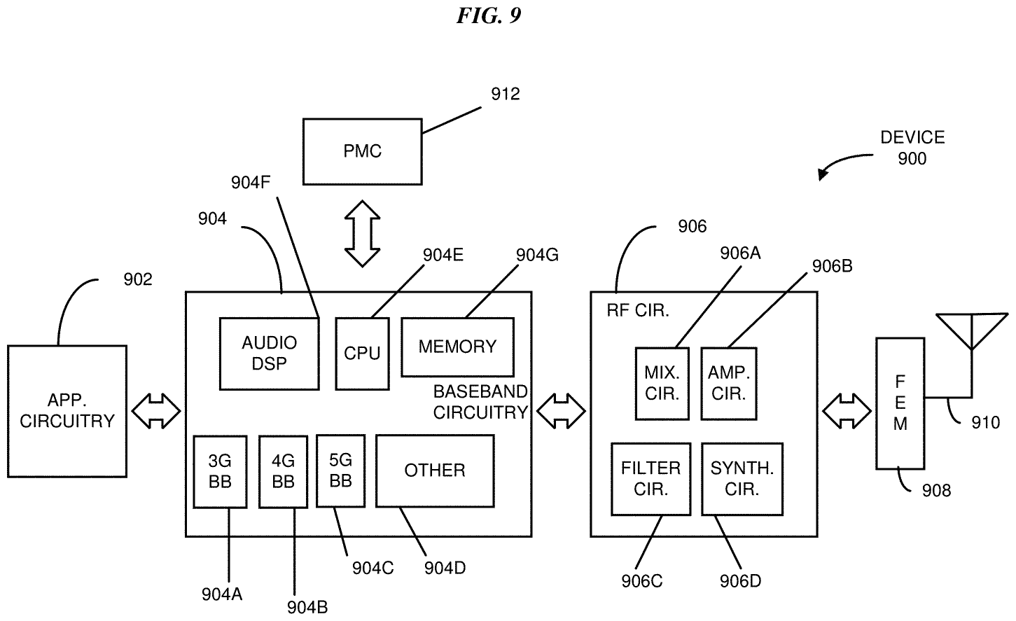

FIG. 9 illustrates example components of a device 900 in accordance with some embodiments. In some embodiments, the device 900 may include application circuitry 902, baseband circuitry 904, Radio Frequency (RF) circuitry 906, front-end module (FEM) circuitry 908, one or more antennas 910, and power management circuitry (PMC) 912 coupled together at least as shown. The components of the illustrated device 900 may be included in a UE or a RAN node. In some embodiments, the device 900 may include less elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 906 and to generate baseband signals for a transmit signal path of the RF circuitry 906. Baseband processing circuity 904 may interface with the application circuitry 902 for generation and processing of the baseband signals and for controlling operations of the RF circuitry 906. For example, in some embodiments, the baseband circuitry 904 may include a third generation (3G) baseband processor 904A, a fourth generation (4G) baseband processor 904B, a fifth generation (5G) baseband processor 904C, or other baseband processor(s) 904D for other existing generations, generations in development or to be developed in the future (e.g., second generation (2G), sixth generation (6G), etc.). The baseband circuitry 904 (e.g., one or more of baseband processors 904A-D) may handle various radio control functions that enable communication with one or more radio networks via the RF circuitry 906. In other embodiments, some or all of the functionality of baseband processors 904A-D may be included in modules stored in the memory 904G and executed via a Central Processing Unit (CPU) 904E. The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include one or more audio digital signal processor(s) (DSP) 904F. The audio DSP(s) 904F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc. to facilitate the communication with the wireless network. RF circuitry 906 may include a receive signal path which may include circuitry to down-convert RF signals received from the FEM circuitry 908 and provide baseband signals to the baseband circuitry 904. RF circuitry 906 may also include a transmit signal path which may include circuitry to up-convert baseband signals provided by the baseband circuitry 904 and provide RF output signals to the FEM circuitry 908 for transmission.

In some embodiments, the receive signal path of the RF circuitry 906 may include mixer circuitry 906a, amplifier circuitry 906b and filter circuitry 906c. In some embodiments, the transmit signal path of the RF circuitry 906 may include filter circuitry 906c and mixer circuitry 906a. RF circuitry 906 may also include synthesizer circuitry 906d for synthesizing a frequency for use by the mixer circuitry 906a of the receive signal path and the transmit signal path. In some embodiments, the mixer circuitry 906a of the receive signal path may be configured to down-convert RF signals received from the FEM circuitry 908 based on the synthesized frequency provided by synthesizer circuitry 906d. The amplifier circuitry 906b may be configured to amplify the down-converted signals and the filter circuitry 906c may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, mixer circuitry 906a of the receive signal path may comprise passive mixers, although the scope of the embodiments is not limited in this respect.

In some embodiments, the mixer circuitry 906a of the transmit signal path may be configured to up-convert input baseband signals based on the synthesized frequency provided by the synthesizer circuitry 906d to generate RF output signals for the FEM circuitry 908. The baseband signals may be provided by the baseband circuitry 904 and may be filtered by filter circuitry 906c.

In some embodiments, the mixer circuitry 906a of the receive signal path and the mixer circuitry 906a of the transmit signal path may include two or more mixers and may be arranged for quadrature downconversion and upconversion, respectively. In some embodiments, the mixer circuitry 906a of the receive signal path and the mixer circuitry 906a of the transmit signal path may include two or more mixers and may be arranged for image rejection (e.g., Hartley image rejection). In some embodiments, the mixer circuitry 906a of the receive signal path and the mixer circuitry 906a may be arranged for direct downconversion and direct upconversion, respectively. In some embodiments, the mixer circuitry 906a of the receive signal path and the mixer circuitry 906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906d may be a fractional-N synthesizer or a fractional N/N+1 synthesizer, although the scope of the embodiments is not limited in this respect as other types of frequency synthesizers may be suitable. For example, synthesizer circuitry 906d may be a delta-sigma synthesizer, a frequency multiplier, or a synthesizer comprising a phase-locked loop with a frequency divider.

The synthesizer circuitry 906d may be configured to synthesize an output frequency for use by the mixer circuitry 906a of the RF circuitry 906 based on a frequency input and a divider control input. In some embodiments, the synthesizer circuitry 906d may be a fractional N/N+1 synthesizer.

In some embodiments, frequency input may be provided by a voltage controlled oscillator (VCO), although that is not a requirement. Divider control input may be provided by either the baseband circuitry 904 or the applications processor 902 depending on the desired output frequency. In some embodiments, a divider control input (e.g., N) may be determined from a look-up table based on a channel indicated by the applications processor 902.

Synthesizer circuitry 906d of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path which may include circuitry configured to operate on RF signals received from one or more antennas 910, amplify the received signals and provide the amplified versions of the received signals to the RF circuitry 906 for further processing. FEM circuitry 908 may also include a transmit signal path which may include circuitry configured to amplify signals for transmission provided by the RF circuitry 906 for transmission by one or more of the one or more antennas 910. In various embodiments, the amplification through the transmit or receive signal paths may be done solely in the RF circuitry 906, solely in the FEM 908, or in both the RF circuitry 906 and the FEM 908.

In some embodiments, the FEM circuitry 908 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission (e.g., by one or more of the one or more antennas 910).

In some embodiments, the PMC 912 may manage power provided to the baseband circuitry 904. In particular, the PMC 912 may control power-source selection, voltage scaling, battery charging, or DC-to-DC conversion. The PMC 912 may often be included when the device 900 is capable of being powered by a battery, for example, when the device is included in a UE. The PMC 912 may increase the power conversion efficiency while providing desirable implementation size and heat dissipation characteristics.

FIG. 9 shows the PMC 912 coupled only with the baseband circuitry 904. However, in other embodiments, the PMC 912 may be additionally or alternatively coupled with, and perform similar power management operations for, other components such as, but not limited to, application circuitry 902, RF circuitry 906, or FEM 908.

In some embodiments, the PMC 912 may control, or otherwise be part of, various power saving mechanisms of the device 900. For example, if the device 900 is in an RRC_Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used execute Layer 3, Layer 2, or Layer 1 functionality, while processors of the application circuitry 904 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

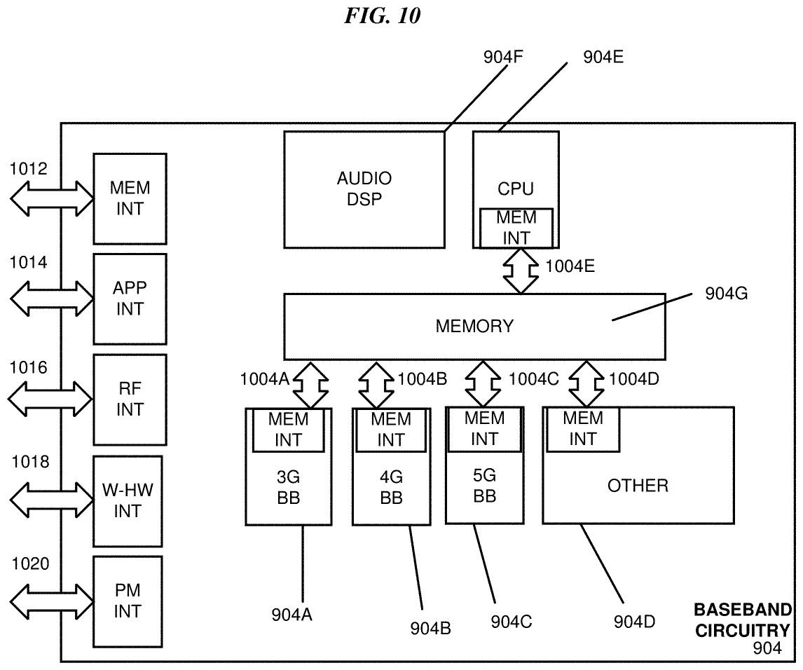

FIG. 10 illustrates example interfaces of baseband circuitry in accordance with some embodiments. As discussed above, the baseband circuitry 904 of FIG. 9 may comprise processors 904A-904E and a memory 904G utilized by said processors. Each of the processors 904A-904E may include a memory interface, 1004A-1004E, respectively, to send/receive data to/from the memory 904G.

The baseband circuitry 904 may further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912.

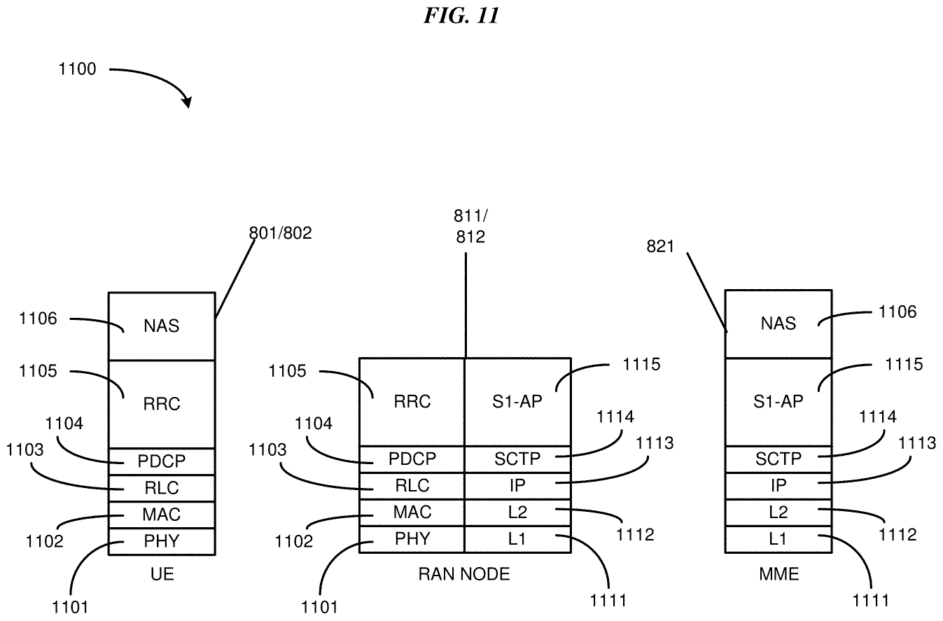

FIG. 11 is an illustration of a control plane protocol stack in accordance with some embodiments. In this embodiment, a control plane 1100 is shown as a communications protocol stack between the UE 801 (or alternatively, the UE 802), the RAN node 811 (or alternatively, the RAN node 812), and the MME 821.

The PHY layer 1101 may transmit or receive information used by the MAC layer 1102 over one or more air interfaces. The PHY layer 1101 may further perform link adaptation or adaptive modulation and coding (AMC), power control, cell search (e.g., for initial synchronization and handover purposes), and other measurements used by higher layers, such as the RRC layer 1105. The PHY layer 1101 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 1102 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1103 may operate in a plurality of modes of operation, including: Transparent Mode (TM), Unacknowledged Mode (UM), and Acknowledged Mode (AM). The RLC layer 1103 may execute transfer of upper layer protocol data units (PDUs), error correction through automatic repeat request (ARQ) for AM data transfers, and concatenation, segmentation and reassembly of RLC SDUs for UM and AM data transfers. The RLC layer 1103 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1104 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1105 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 801 and the RAN node 811 may utilize a Uu interface (e.g., an LTE-Uu interface) to exchange control plane data via a protocol stack comprising the PHY layer 1101, the MAC layer 1102, the RLC layer 1103, the PDCP layer 1104, and the RRC layer 1105.

The non-access stratum (NAS) protocols 1106 form the highest stratum of the control plane between the UE 801 and the MME 821. The NAS protocols 1106 support the mobility of the UE 801 and the session management procedures to establish and maintain IP connectivity between the UE 801 and the P-GW 823.

The S1 Application Protocol (S1-AP) layer 1115 may support the functions of the S1 interface and comprise Elementary Procedures (EPs). An EP is a unit of interaction between the RAN node 811 and the CN 820. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 1114 may ensure reliable delivery of signaling messages between the RAN node 811 and the MME 821 based, in part, on the IP protocol, supported by the IP layer 1113. The L2 layer 1112 and the L1 layer 1111 may refer to communication links (e.g., wired or wireless) used by the RAN node and the MME to exchange information.

The RAN node 811 and the MME 821 may utilize an S1-MME interface to exchange control plane data via a protocol stack comprising the L1 layer 1111, the L2 layer 1112, the IP layer 1113, the SCTP layer 1114, and the S1-AP layer 1115.

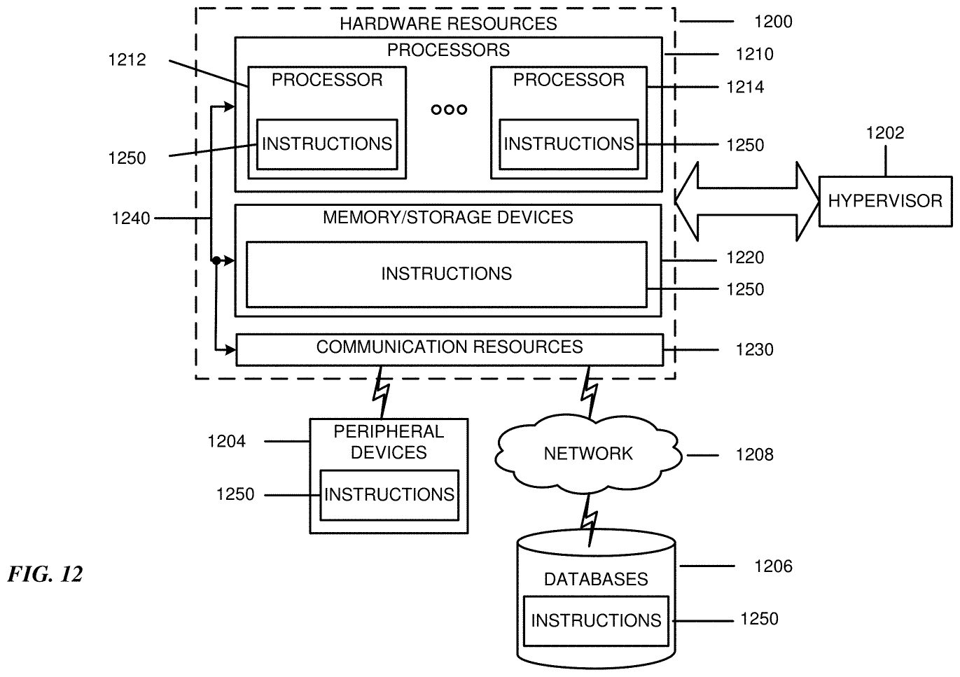

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For embodiments where node virtualization (e.g., NFV) is utilized, a hypervisor 1202 may be executed to provide an execution environment for one or more network slices/sub-slices to utilize the hardware resources 1200

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, ASICs, programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

The following examples pertain to further embodiments:

Example 1 is an apparatus, comprising: a memory interface; and circuitry for user equipment (UE), the circuitry to: process a radio resource control (RRC) message received from a serving evolved node B (eNB) of the UE, the RRC message to comprise discovery signal measurement timing configuration (DMTC) information for an unlicensed carrier frequency; determine a wideband coverage enhancement (WCE) DMTC applicable to the unlicensed carrier frequency based on one or more DMTC parameter values indicated by the DMTC information; and perform one or more WCE DRS measurements on the unlicensed carrier frequency in accordance with the applicable WCE DMTC.

Example 2 is the apparatus of Example 1, the one or more DMTC parameter values to include a value for a DMTC periodicity parameter of the WCE DMTC.

Example 3 is the apparatus of Example 1, the one or more DMTC parameter values to include a value for a DMTC window size parameter of the WCE DMTC.

Example 4 is the apparatus of Example 1, the one or more DMTC parameter values to include a value for a DMTC offset parameter of the WCE DMTC.

Example 5 is the apparatus of Example 1, the RRC message to contain measurement gap configuration (MGC) information including information indicating MGC parameter values for a WCE MGC of the UE.

Example 6 is the apparatus of Example 5, the MGC information to include information indicating MGC parameter values for a non-WCE MGC of the UE.

Example 7 is a device, comprising: the apparatus of any of Examples 1 to 6; one or more application processors; radio frequency (RF) circuitry; and one or more RF antennas.

Example 8 is an apparatus, comprising: a memory interface; and circuitry for an evolved node B (eNB), the circuitry to: identify an unlicensed carrier frequency on which user equipment (UE) served by the eNB is to perform wideband coverage enhancement (WCE) discovery reference signal (DRS) measurements; select one or more discovery signal measurement timing configuration (DMTC) parameter values for a WCE DMTC to be provided to the UE to control WCE DRS measurements of the UE on the unlicensed carrier frequency; and generate a radio resource control (RRC) message for transmission to the UE, the RRC message to contain DMTC information including information indicating the one or more DMTC parameter values.

Example 9 is the apparatus of Example 8, the one or more DMTC parameter values to include a value for a DMTC periodicity parameter of the WCE DMTC.

Example 10 is the apparatus of Example 8, the one or more DMTC parameter values to include a value for a DMTC window size parameter of the WCE DMTC.

Example 11 is the apparatus of Example 8, the one or more DMTC parameter values to include a value for a DMTC offset parameter of the WCE DMTC.

Example 12 is the apparatus of Example 8, the RRC message to contain measurement gap configuration (MGC) information including information indicating MGC parameter values for a WCE MGC of the UE.

Example 13 is the apparatus of Example 12, the MGC information to include information indicating MGC parameter values for a non-WCE MGC of the UE.

Example 14 is computer-readable storage media having stored thereon instructions that, when executed by processing circuitry of user equipment (UE), cause the UE to: process a radio resource control (RRC) message received from a serving evolved node B (eNB) of the UE, the RRC message to comprise discovery signal measurement timing configuration (DMTC) information for an unlicensed carrier frequency; determine a wideband coverage enhancement (WCE) DMTC applicable to the unlicensed carrier frequency based on one or more DMTC parameter values indicated by the DMTC information; and perform one or more WCE DRS measurements on the unlicensed carrier frequency in accordance with the applicable WCE DMTC.

Example 15 is the computer-readable storage media of Example 14, the one or more DMTC parameter values to include a value for a DMTC periodicity parameter of the WCE DMTC.

Example 16 is the computer-readable storage media of Example 14, the one or more DMTC parameter values to include a value for a DMTC window size parameter of the WCE DMTC.

Example 17 is the computer-readable storage media of Example 14, the one or more DMTC parameter values to include a value for a DMTC offset parameter of the WCE DMTC.

Example 18 is the computer-readable storage media of Example 14, the RRC message to contain measurement gap configuration (MGC) information including information indicating MGC parameter values for a WCE MGC of the UE.

Example 19 is the computer-readable storage media of Example 18, the MGC information to include information indicating MGC parameter values for a non-WCE MGC of the UE.

Example 20 is computer-readable storage media having stored thereon instructions that, when executed by processing circuitry of an evolved node B (eNB), cause the eNB to: identify an unlicensed carrier frequency on which user equipment (UE) served by the eNB is to perform wideband coverage enhancement (WCE) discovery reference signal (DRS) measurements; select one or more discovery signal measurement timing configuration (DMTC) parameter values for a WCE DMTC to be provided to the UE to control WCE DRS measurements of the UE on the unlicensed carrier frequency; and generate a radio resource control (RRC) message for transmission to the UE, the RRC message to contain DMTC information including information indicating the one or more DMTC parameter values.

Example 21 is the computer-readable storage media of Example 20, the one or more DMTC parameter values to include a value for a DMTC periodicity parameter of the WCE DMTC.

Example 22 is the computer-readable storage media of Example 20, the one or more DMTC parameter values to include a value for a DMTC window size parameter of the WCE DMTC.

Example 23 is the computer-readable storage media of Example 20, the one or more DMTC parameter values to include a value for a DMTC offset parameter of the WCE DMTC.

Example 24 is the computer-readable storage media of Example 20, the RRC message to contain measurement gap configuration (MGC) information including information indicating MGC parameter values for a WCE MGC of the UE.

Example 25 is the computer-readable storage media of Example 24, the MGC information to include information indicating MGC parameter values for a non-WCE MGC of the UE.

Example 26 is a method, comprising: processing, by circuitry of user equipment (UE), a radio resource control (RRC) message received from a serving evolved node B (eNB) of the UE, the RRC message to comprise discovery signal measurement timing configuration (DMTC) information for an unlicensed carrier frequency; determining a wideband coverage enhancement (WCE) DMTC applicable to the unlicensed carrier frequency based on one or more DMTC parameter values indicated by the DMTC information; and performing one or more WCE DRS measurements on the unlicensed carrier frequency in accordance with the applicable WCE DMTC.

Example 27 is the method of Example 26, the one or more DMTC parameter values to include a value for a DMTC periodicity parameter of the WCE DMTC.

Example 28 is the method of Example 26, the one or more DMTC parameter values to include a value for a DMTC window size parameter of the WCE DMTC.

Example 29 is the method of Example 26, the one or more DMTC parameter values to include a value for a DMTC offset parameter of the WCE DMTC.

Example 30 is the method of Example 26, the RRC message to contain measurement gap configuration (MGC) information including information indicating MGC parameter values for a WCE MGC of the UE.

Example 31 is the method of Example 30, the MGC information to include information indicating MGC parameter values for a non-WCE MGC of the UE.

Example 32 is an apparatus, comprising means for performing the method of any of Examples 26 to 31.

Example 33 is a method, comprising: identifying, by circuitry of an evolved node B (eNB), an unlicensed carrier frequency on which user equipment (UE) served by the eNB is to perform wideband coverage enhancement (WCE) discovery reference signal (DRS) measurements; selecting one or more discovery signal measurement timing configuration (DMTC) parameter values for a WCE DMTC to be provided to the UE to control WCE DRS measurements of the UE on the unlicensed carrier frequency; and generating a radio resource control (RRC) message for transmission to the UE, the RRC message to contain DMTC information including information indicating the one or more DMTC parameter values.

Example 34 is the method of Example 33, the one or more DMTC parameter values to include a value for a DMTC periodicity parameter of the WCE DMTC.

Example 35 is the method of Example 33, the one or more DMTC parameter values to include a value for a DMTC window size parameter of the WCE DMTC.

Example 36 is the method of Example 33, the one or more DMTC parameter values to include a value for a DMTC offset parameter of the WCE DMTC.

Example 37 is the method of Example 33, the RRC message to contain measurement gap configuration (MGC) information including information indicating MGC parameter values for a WCE MGC of the UE.

Example 38 is the method of Example 37, the MGC information to include information indicating MGC parameter values for a non-WCE MGC of the UE.

Example 39 is an apparatus, comprising means for performing the method of any of Examples 33 to 38.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It should be noted that the methods described herein do not necessarily have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided merely to allow the reader to ascertain the general nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1.-25. (canceled)

26. An apparatus, comprising:
a memory interface; and
circuitry for an evolved node B (eNB), the circuitry to generate a radio resource control (RRC) message for transmission to a user equipment (UE), the RRC message to contain measurement configuration information comprising:
discovery signal measurement timing configuration (DMTC) information for a wideband coverage enhancement (WCE) DMTC; and
measurement gap configuration (MGC) information for a WCE MGC.

27. The apparatus of claim 26, wherein the measurement configuration information is comprised in a MulteFire (MF) MeasConfig-MF information element.

28. The apparatus of claim 26, wherein the WCE DMTC information is comprised in a MulteFire (MF) MeasDS-Config-MF information element.

29. The apparatus of claim 26, wherein the MGC information is comprised in a MulteFire (MF) MeasGapConfig-MF information element.

30. The apparatus of claim 26, the circuitry to further identify an unlicensed carrier frequency on which the UE served by the eNB is to perform WCE discovery reference signal (DRS) measurements.

31. The apparatus of claim 30, the circuitry to further select one or more DMTC parameter values for the WCE DMTC to be provided to the UE to control WCE DRS measurements of the UE on the unlicensed carrier frequency.

32. The apparatus of claim 31, the one or more DMTC parameter values to include a value for a DMTC periodicity parameter of the WCE DMTC.

33. The apparatus of claim 31, the one or more DMTC parameter values to include a value for a DMTC window size parameter of the WCE DMTC.

34. The apparatus of claim 31, the one or more DMTC parameter values to include a value for a DMTC offset parameter of the WCE DMTC.

35. The apparatus of claim 26, the MGC information to include information indicating MGC parameter values for a non-WCE MGC of the UE.

36. An apparatus, comprising:
a memory interface; and
circuitry for user equipment (UE), the circuitry to process a radio resource control (RRC) message received from a serving evolved node B (eNB) of the UE, the RRC message comprising measurement configuration information, the measurement configuration information comprising:
discovery signal measurement timing configuration (DMTC) information for an unlicensed carrier frequency; and
measurement gap configuration (MGC) information for a wideband coverage enhancement (WCE) MGC.

37. The apparatus of claim 36, wherein the measurement configuration information is comprised in a MulteFire (MF) MeasConfig-MF information element, the WCE DMTC information is comprised in a MulteFire (MF) MeasDSConfig-MF information element, and the MGC information is comprised in a MulteFire (MF) MeasGapConfig-MF information element.

38. The apparatus of claim 36, the circuitry to further:
determine WCE DMTC applicable to the unlicensed carrier frequency based on the DMTC information; and
perform one or more WCE DRS measurements on the unlicensed carrier frequency in accordance with the applicable WCE DMTC.

39. The apparatus of claim 38, the circuitry to further process one or more DMTC parameter values.

40. The apparatus of claim 39, the one or more DMTC parameter values to include a value for a DMTC periodicity parameter of the WCE DMTC.

41. The apparatus of claim 39, the one or more DMTC parameter values to include a value for a DMTC window size parameter of the WCE DMTC.

42. The apparatus of claim 39, the one or more DMTC parameter values to include a value for a DMTC offset parameter of the WCE DMTC.

43. The apparatus of claim 36, the MGC information to include information indicating MGC parameter values for a non-WCE MGC of the UE.

44. Computer-readable storage media having stored thereon instructions that, when executed by processing circuitry of an evolved node B (eNB), cause the eNB to generate a radio resource control (RRC) message for transmission to the UE, the RRC message to contain measurement configuration information comprising:
discovery signal measurement timing configuration (DMTC) information for a wideband coverage enhancement (WCE) DMTC; and
measurement gap configuration (MGC) information for a WCE MGC.

45. The computer-readable storage media of claim 44, the measurement configuration information to be comprised in a MulteFire (MF) MeasConfig-MF information element, the WCE DMTC information to be comprised in a MulteFire (MF) MeasDS-Config-MS information element, and the MGC information to be comprised in a MulteFire (MF) MeasGapConfig-MF information element.

46. The computer-readable storage media of claim 44, the instructions, when executed by processing circuitry of the eNB, cause the eNB to further identify an unlicensed carrier frequency on which user equipment (UE) served by the eNB is to perform wideband coverage enhancement (WCE) discovery reference signal (DRS) measurements.

47. The computer-readable storage media of claim 44, the DMTC information comprising one or more DMTC parameter values for the WCE DMTC to be provided to the UE to control WCE DRS measurements of the UE on the unlicensed carrier frequency.

48. The computer-readable storage media of claim 47, the one or more DMTC parameter values to include a value for one or more of a DMTC periodicity parameter, a DMTC window size parameter, and a DMTC offset parameter, of the WCE DMTC.

49. Computer-readable storage media having stored thereon instructions that, when executed by processing circuitry of user equipment (UE), cause the UE to:
process a radio resource control (RRC) message received from a serving evolved node B (eNB) of the UE, the RRC message comprising measurement configuration information, the measurement configuration information comprising:
discovery signal measurement timing configuration (DMTC) information; and
measurement gap configuration (MGC) information for a wideband coverage enhancement (WCE) MGC.

50. The computer-readable storage media of claim 49, the measurement configuration information to be comprised in a MulteFire (MF) MeasConfig-MF information element, the WCE DMTC information to be comprised in a MulteFire (MF) MeasDSConfig-MF information element, and the MGC information to be comprised in a MulteFire (MF) MeasGapConfig-MF information element.

51. The computer-readable storage media of claim 49, having stored thereon instructions that, when executed by processing circuitry of the UE, cause the UE to further:
determine WCE DMTC applicable to an unlicensed carrier frequency based the DMTC information; and
perform one or more WCE discovery reference signal (DRS) measurements on the unlicensed carrier frequency in accordance with the applicable WCE DMTC.

52. The computer-readable storage media of claim 49, the DMTC information comprising one or more DMTC parameter values, the one or more DMTC parameter values to include a value for one or more of a DMTC periodicity parameter, a DMTC window size parameter, and a DMTC offset parameter, of the WCE DMTC.

53. The computer-readable storage media of claim 49, the MGC information to include information indicating MGC parameter values for a non-WCE MGC of the UE.
